(19) United States
(12) Patent Application Publication
(10) Pub. No.: US 2016/0011709 A1
(43) Pub. Date: Jan. 14, 2016

(54) PORTABLE ELECTRONIC DEVICE FOR INFORMATION DISPLAY

(71) Applicant: The Swatch Group Research and Development Ltd, Marin (CH)

(72) Inventors: Cedric NICOLAS, Neuchatel (CH); Pascal HECK, Erlach (CH); Pierry VUILLE, Les Emibois (CH); David HOOVER, La Sarraz (CH)

(73) Assignee: The Swatch Group Research and Development Ltd, Marin (CH)

(21) Appl. No.: 14/714,515

(22) Filed: May 18, 2015

(30) Foreign Application Priority Data
Jul. 10, 2014 (EP) 14176614.7

(51) Int. Cl. G06F 3/041; G06F 1/32

(52) U.S. Cl. CPC G06F 3/0414; G06F 3/0416; G06F 1/3262; G06F 2203/04105

(57) ABSTRACT

The invention relates to a portable electronic device capable of displaying information, attached to the wrist and including:
a bracelet formed by a flexible element,
an electronic assembly,
display means,
an energy source.

According to the invention, the device includes control means including at least one strain gauge, capable, by the application of pressure to the strain gauge, of generating a control signal which is applied to said electronic assembly, the direction and the position of the pressure on said strain gauge permitting the display of information and/or activation of a predetermined function.

This application claims priority from European patent application 14176614.7 filed Jul. 10, 2014, the entire disclosure of which is hereby incorporated herein by reference.

### FIELD OF THE INVENTION

The present invention concerns a portable electronic device able to display at least one piece of information, and more particularly a portable electronic device such as a watch.

### BACKGROUND OF THE INVENTION

Generally speaking, such devices make it possible, for example, to display the time, while offering a reduced space requirement.

There are numerous known devices for entering data into electronic means intended to process such data. These devices may include, for example, touch keys, each of the touch keys being associated with a function. EP Patent No 1394640 discloses such a device including means for activating a function, such as starting a chronometer or setting the time. Such touch keys advantageously replace the usual push buttons.

Such a watch has several drawbacks, however. One of these drawbacks lies in the fact that the touch keys are very touch sensitive. Thus the watch user merely needs to inadvertently brush against one of the touch keys on the keyboard for the character or operation corresponding to the key to be immediately selected and activated by the electronic data processing circuit.

Further, the tactile sensors must be constantly powered by an electric current to be ready for use when the time comes, which causes a problem of electrical power consumption.

There are also wristwatch type devices having a touch screen. Such a device is disclosed in EP Patent No 2449434 and has a digital matrix display, a touch glass provided with a plurality of electrodes, and a processing circuit for interpreting the electrode signals in order to select a function.

One drawback of such a device is that the electronic means incorporated in the watch have to develop complex identification strategies, which also causes a problem of electrical power consumption, requiring the device to be regularly charged.

EP Patent No 1235122 discloses a timepiece, in particular a wristwatch, a touch pad allowing a user to select one of the watch functions, the touch screen being associated with a strain gauge for confirming the selection of the desired function and/or activating the function by the application of mechanical pressure to the watch.

One drawback of such a device is that it is tiresome to select and activate the desired function. Indeed, the user has to operate the watch and perform several operations before being able to activate the desired function.

### SUMMARY OF THE INVENTION

It is an object of the invention to overcome the various drawbacks of these known techniques.

More specifically, it is an object of the invention to provide an electronic device which is simple to operate and which no longer requires push buttons.

It is also an object of the invention, at least in a particular embodiment, to provide a device that is compact and inexpensive.

These objects, in addition to others, which will appear more clearly below, are achieved according to the invention with the aid of a portable electronic device able to display at least one piece of information, said electronic circuit being attachable to a part of a user's body, particularly, the wrist, said electronic device including:
a bracelet or strap including a semi-rigid body formed by a lower flexible element and an upper flexible element having a base,
an electronic assembly,
display means for displaying at least one piece of information,
an energy source powering said electronic assembly and said display means.

According to the invention, the device includes control means preferably including at least one strain gauge, capable, by the application of pressure to said strain gauge, of generating a control signal which is applied to said electronic assembly, the direction and the position of the pressure on said strain gauge permitting the display of information and/or activation of a predetermined function.

According to optional characteristics of the invention, taken alone or in combination:
said bracelet or strap is in one piece, of circular shape and has at least one median portion and two lateral portions;
said control means include at least two strain gauges;
one strain gauge is disposed on each lateral portion of said bracelet;
one strain gauge is disposed on said at least one median portion of said bracelet;
the electronic assembly distinguishes a short press from a long press exerted on at least one strain gauge or a set of strain gauges;
the electronic assembly detects the pressure force exerted on at least one strain gauge or a set of strain gauges;
the confirmation and/or validation of the desired function is accomplished by pressing on one of said strain gauges;
the hours are scrolled through, particularly during setting of the time, more or less rapidly according to the pressure exerted on at least one strain gauge or set of strain gauges;
a short press on a strain gauge activates the chronograph and another press on the same strain gauge stops the chronograph;
a long press in the vertical direction on two strain gauges permits selection of an alarm time;
a long press in the horizontal direction on two gauges permits activation of said electronic device;
said control means include a flexible body in the form of a flexible band;
said at least one strain gauge is bonded onto said flexible band.

Thus, the subject of the present invention, by means of the different functional and structural aspects described above, provides a reliable and easy-to-use electronic device.

### BRIEF DESCRIPTION OF THE DRAWINGS

Other characteristics and advantages of the invention will appear more clearly upon reading the following description of a specific embodiment of the invention, given simply by way of illustrative and non-limiting example, and the annexed Figures, among which:

FIG. 1 is an exploded view of the electronic device according to the invention;

FIG. 2 is a detailed view of the electronic device according to the invention;

FIG. 3 is a perspective view of the electronic device according to the invention.

### DETAILED DESCRIPTION OF PREFERRED EMBODIMENTS

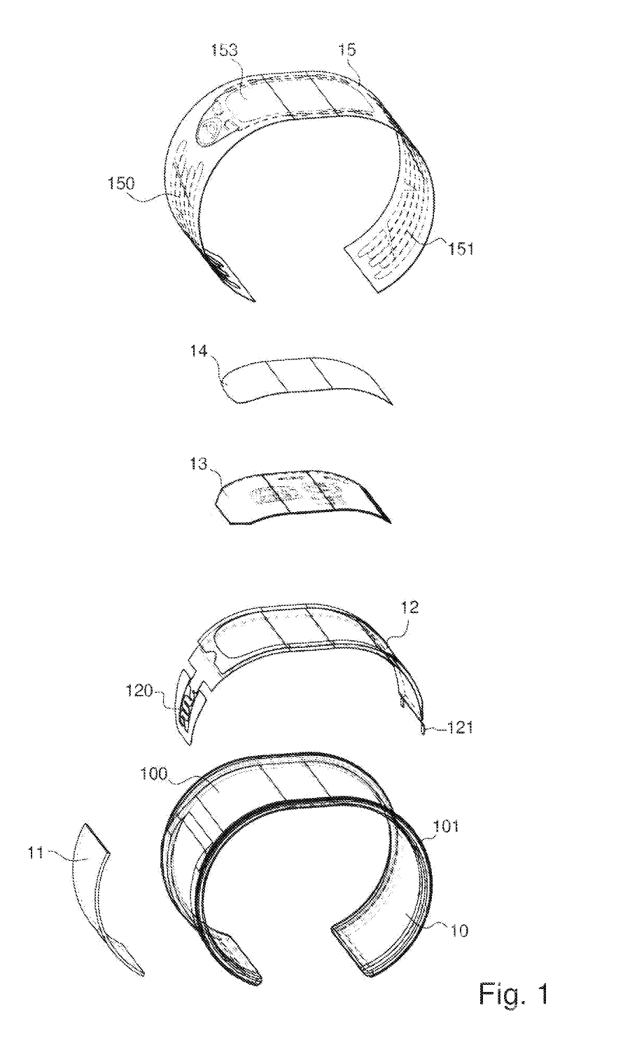

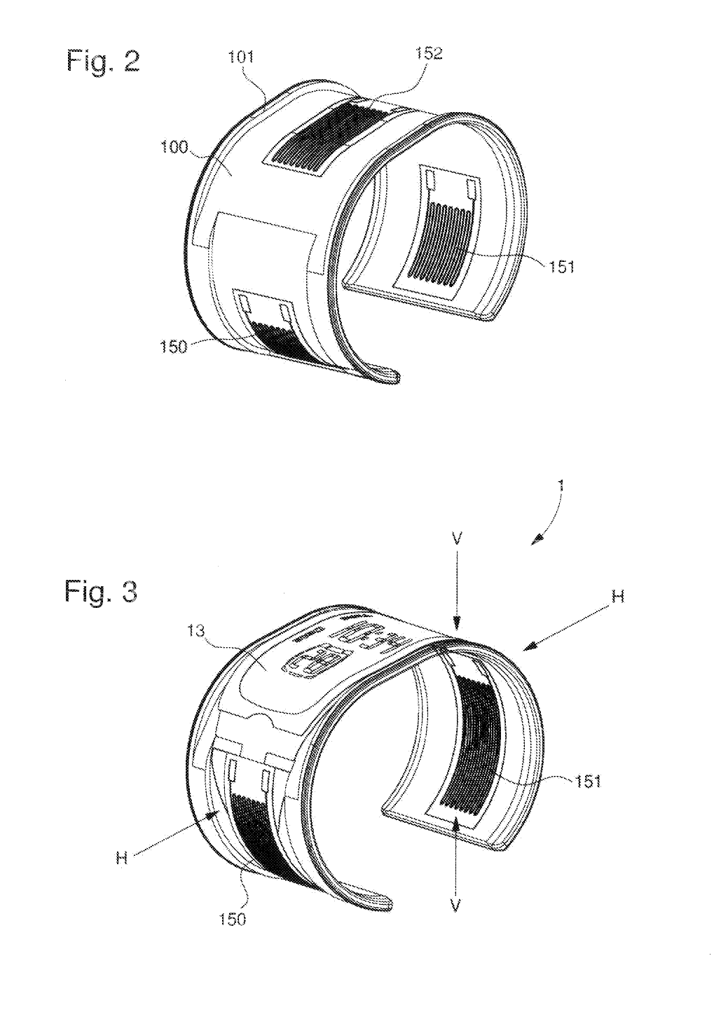

An electronic device according to an example embodiment will now be described below with reference jointly to FIGS. 1 to 3.

As mentioned above, the general principle of the invention lies in the implementation of a portable electronic device 1, and more specifically a watch, associated with at least one strain gauge for selecting at least one desired function and/or for activating said function by the application of pressure on the watch bracelet or strap.

In this example, device 1 is formed of a bracelet or strap 10 formed by a semi-rigid, C-shaped element having a base 100 and a peripheral edge 101 so as to form a receptacle able to receive the components of electronic device 1. According to another embodiment, the bracelet has a closed circular shape, the bracelet then being capable of deforming diametrically to be placed on the wrist.

Bracelet 10 can be manufactured in a slightly deformable plastic material so as to fit the morphology of the user; the use of a metal material may also be envisaged. It will be understood here that other materials could have been envisaged by those skilled in the art within the scope of the present invention.

The receptacle thereby formed by bracelet 10 is capable of receiving an electronic assembly 12, such as a printed circuit board (PCB), with which are associated display means 13, such as a liquid crystal screen, for displaying at least one piece of information, such as the time or the date, securing means 14, such as an optical adhesive made of a transparent material and capable of being disposed on display means 13 in order to protect the liquid crystal screen from scratches, for example.

Means for lighting the liquid crystal screen may be disposed underneath the screen in order to backlight it.

The device also includes an energy source 11 intended to power electronic assembly 12 and display means 13. This energy source may include a rechargeable battery, the battery being sufficiently thin to limit the space requirement of device 1.

Device 1 may thus include a micro-USB type connector for connecting device 1 to an electrical power source in order to charge the battery.

According to the invention, the size and resolution of the screen are sufficient to simultaneously display several pieces of information, for example the current time, the date or the state of the battery.

According to a particular embodiment of the invention, a light sensor may be provided to adapt the brightness of the screen/backlighting according to ambient light.

Control means 15 of device 1 take the form of an upper flexible film that is positioned above display means 13 and covering electronic assembly 12, an opening 153 being provided for display means 13. The set of constituent elements of device 1 is held in place in the receptacle of bracelet 10 by means of optical adhesive 14 positioned on bracelet 10. Preferably, the optical adhesive is made of a flexible, deformable material so as to be easily deformed on strain gauges 150, 151.

According to the invention, control means 15 include at least one set of two strain gauges 150, 151 for displaying information and/or activating a function, the display of information and/or activation of the function being accomplished by the application of pressure on at least one of strain gauges 150, 151 which generates a control signal that is sent to electronic assembly 12. The device is thus devoid of push buttons for activating a function or displaying information, and allows the device to remain very thin.

Electronic assembly 12 includes, in particular, processing means formed by a microcontroller and a memory, for interpreting the signals from strain gauges 150, 150, and for displaying, on display means 13, the information associated with such signals, or for selecting one function from among several available functions in accordance with the signals, the functions being stored in the memory of electronic assembly 12.

As can be seen in FIG. 1, electronic assembly 12 includes connectors 120, 121 configured to cooperate with battery 11 and strain gauges 150, 151. This arrangement of the constituent elements of device 1 provides a relatively compact device.

According to the illustrated example, display means 13 are positioned above electronic assembly 12 so as to be easily connected thereto, thereby limiting the space requirement of device 1.

According to the invention, and as illustrated in the Figures, control means 15 take the form of a flexible band to which are attached, by bonding for example, strain gauges 150, 151, the flexible band having a recess at the centre thereof for display means 13. Advantageously, each strain gauge 150, 151 is arranged to rest on each strand of bracelet 10.

According to the invention, portable electronic device 1 also includes a strain gauge 152 arranged at the centre of bracelet 10, underneath electronic assembly 12, the gauge cooperating directly with electronic assembly 12.

This arrangement of strain gauges 150, 151 and 152 permits differentiation of several directions and positions of the pressure exerted on the strain gauges in order to attribute different functions thereto.

According to the invention, electronic assembly 12 is capable of differentiating a short press from a long press exerted on at least one strain gauge 150 or set of strain gauges 150/151, or 150/152, 151/152. This aspect of the invention permits the number of possible functions of the device to be increased.

According to a particularly simple aspect of the invention, the confirmation and/or validation of the desired function is accomplished by pressing on one of said strain gauges 150, 151, 152.

For example, one short press exerted on one of strain gauges 150, 151, or 152 can be associated with activation of the chronograph and another short press on the same strain gauge stops the chronograph.

According to another example of a possible function, one long press in the vertical direction on two strain gauges 150, 152 provides access to selection of the alarm time. Evidently, the pressure exerted on the strain gauges can be applied horizontally in the direction of arrows H or equally vertically in the direction of arrows V, as illustrated in FIG. 3, activation of the functions depending on how the functions have been programmed.

A function can also be set up so that one long press in the horizontal direction on two gauges 150, 151 activates the electronic device.

A function can also be applied to a single long or short press on each of strain gauges 150, 151, 152. Thus, one long press on strain gauge 152 may, for example, activate the lighting of the liquid crystal screen.

According to the invention, electronic assembly 12 detects the pressure force exerted on at least one strain gauge 150, 151, 152 or a set of strain gauges; detection of the force applied on the strain gauge(s) 150, 151, 152 may be achieved by crossing thresholds pre-stored in the memory.

Detection of the applied force may implement other functions, such as scrolling through the hours during time setting, for example. The hours are scrolled through more or less rapidly according to the pressure exerted on at least one strain gauge or set of strain gauges 150, 151, 152.

All the functions known to those skilled in the art may thus be stored in the memory of electronic assembly 12 and easily be activated by means of strain gauges 150, 151, 152.

Electronic device 1 is assembled as follows. Liquid crystal screen 13 and battery 11 are assembly to PCB 12, then fixed to upper film 15 by means of optical adhesive 14. According to the illustrated embodiment, strain gauges 150, 151, 152 are fixed to upper film 15 and connected to PCB 12. This element comprising all the electronic circuits is then bonded to bracelet 100 over the entire periphery of upper film 15 and underneath each strain gauge 150, 151, 152 so as to ensure that the gauges are secured to bracelet 100 and can measure the deformation of bracelet 100.

According to another embodiment, not shown in the Figures, strain gauges 150, 151, 152 are fixed to PCB 12 by welding.

A specific adhesive may be used during assembly of device 1 to make the device at least resistant to splashes.

As a result of the various aspects of the invention, there is provided an electronic device 1 that is easy for a user to operate and use, and which does not require push buttons to be operated in order to activate the functions.

Naturally, other embodiments may be envisaged by those skilled in the art without thereby departing from the scope of the invention defined by the claims below.

### LIST OF PARTS

1. Portable electronic device,
10. Bracelet or strap,
100. Base of bracelet,
101. Peripheral edge of bracelet,
11. Battery
12. Electronic assembly,
120, 121. Connectors,
13. Display means,
14. Optical adhesive,
15. Flexible upper film,
150, 151, 152. Strain gauges,
153. Opening,
H. Pressure in the horizontal direction,
V. Pressure in the vertical direction.

What is claimed is:

1. A portable electronic device capable of displaying at least one piece of information, the electronic device being capable of attachment to a part of a user's body, in particular the wrist, said electronic device including:
a bracelet or strap formed by a semi-rigid body having a base,
an electronic assembly,
display means for displaying at least one piece of information,
an energy source powering said electronic assembly and said display means,
wherein said device includes control means including at least one strain gauge, capable, by the application of pressure on said strain gauge, of generating a control signal which is applied to said electronic assembly, the direction and the position of the pressure on said strain gauge permitting the display of information and/or activation of a predetermined function.

2. The portable electronic device according to claim 1, wherein said bracelet is in one piece, of circular shape and has at least one median portion and two lateral portions.

3. The portable electronic device according to claim 1, wherein said control means include at least two strain gauges.

4. The portable electronic device according to claim 3, wherein a strain gauge is disposed on each lateral portion of said bracelet.

5. The portable electronic device according to claim 1, wherein a strain gauge is disposed on said at least one median portion of said bracelet.

6. The portable electronic device according to claim 1, wherein the electronic assembly differentiates a short press from a long press exerted on at least one strain gauge or a set of strain gauges.

7. The portable electronic device according to claim 1, wherein the electronic assembly detects the pressure force exerted on at least one strain gauge or a set of strain gauges.

8. The portable electronic device according to claim 1, wherein the confirmation and/or validation of the desired function is accomplished by pressing on one of said strain gauges.

9. The portable electronic device according to claim 1, wherein the hours are scrolled through, particularly during time setting, more or less rapidly according to the pressure force exerted on at least one strain gauge or a set of strain gauges.

10. The portable electronic device according to claim 1, wherein a short press on a strain gauge corresponds to activation of the chronometer and another press on the same strain gauge stops the chronometer.

11. The portable electronic device according to claim 3, wherein a long press in the vertical direction on two strain gauges permits selection of an alarm time.

12. The portable electronic device according to claim 3, wherein a long press in the horizontal direction on two strain gauges permits activation of said electronic device.
